(19) United States
(12) Patent Application Publication
(10) Pub. No.: US 2008/0207843 A1
(43) Pub. Date: Aug. 28, 2008

(54) Method To Manufacture A Compartmentalized Pellet Directly From A Reactor

(76) Inventors: Gianluca Ferrari, Medina, OH (US); Dan Gastaldo, Middleburg Heights, OH (US); Chang Kiang, (US); Edwin Andrew Sisson, Medina, OH (US)

Correspondence Address: EDWIN A. SISSON , ATTORNEY AT LAW , LLC, P.O. BOX 603, SHARON CENTER, OH, 44274-0603, US

(21) Appl. No.: 12/038,455

(22) Filed: Feb. 27, 2008

Related U.S. Application Data
(60) Provisional application No. 60/891,938, filed on Feb. 27, 2007.

(51) Int. Cl. C08G 63/00

(52) U.S. Cl. 525/418

(57) ABSTRACT

This specification discloses how to make a compartmentalized pellet from a reactor by not reducing the temperature of the reacted product to below its glass transition temperature.

### PRIORITY AND CROSS REFERENCES

This patent application claims the benefit of the priority of U.S. Provisional Patent Application Ser. No. 60/891,938 filed Feb. 27, 2007.

### FIELD OF INVENTION

The field of this invention is to polymer manufacturing.

### BACKGROUND

U.S. Pat. No. 5,340,884 teaches that a polyamide may be added in the late stages of polyester manufacture. For example, the polyamide can be blended with the molten polyester as it is removed from the polycondensation reactor, before it is pelletized. This method, however, is not desirable if the polyester/polyamide blend will be subjected to solid state polymerization since undesirable color and/or haze may develop during extended time at elevated temperatures.

United States Patent Application 20050261126 teaches the use of the compartmentalized pellet to simultaneously solid phase polymerize polyester and polyamide in the same pellet.

By forming the compartmentalized pellet after the reaction step before the reacted material cools below its glass transition temperature (Tg), significant economies of scale and reduced investment are realized.

### SUMMARY

Disclosed in this specification is a method to manufacture compartmentalized pellets wherein the pellets are comprised of at least a first compartment and a second compartment wherein the method comprises the steps of manufacturing a first compound in a reaction vessel, removing the first compound from the reaction vessel, introducing the first compound in liquid form to a compartmentalized article forming apparatus so as to place at least a portion of the first compound in the first compartment of a compartmentalized article formed by the compartmentalized article forming apparatus, wherein the temperature of the first compound is kept at or above its glass transition temperature (Tg) during the time period from removal of the first compound from the reaction vessel and introduction of the first compound into the compartmentalized article forming apparatus, introducing a second compound in liquid form to the compartmentalized article forming apparatus so as to place at least some of the second compound into the second compartment of the compartmentalized article, converting the compartmentalized article into smaller compartmentalized articles.

It is further disclosed that the first compound is a thermoplastic polymer and that the compartmentalized article forming apparatus is a die designed to form a core sheath strand. It is also further disclosed that the second compound is a thermoplastic polymer that is not compositionally similar to the first compound or that is compositionally similar to the first compound.

It is also disclosed that the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus. Additives in the first or second compound are also disclosed.

### BRIEF DESCRIPTION OF THE DRAWINGS

FIG. 1 depicts a resin pellet with two compartments or zones in the core-sheath configuration.

FIG. 2 depicts a resin pellet with two compartments or zones in the core-sheath configuration where the core is encapsulated, surrounded, or enclosed by an outer sheath layer.

FIG. 3 depicts a resin pellet with three compartments or zones in a multi-layered or sandwich configuration.

FIG. 4 depicts a resin pellet of three compartmentalized zones configured in two concentric layers surrounding a core.

FIGS. 5A, 5B, 5C depict examples of various resin pellet configurations of two compartments, where the compartments lay beside each other in what is called the side-by-side configuration.

FIG. 6 is a schematic of the process.

### DETAILED DESCRIPTION

Described in this specification is the method to produce a multi-component pellet, wherein the multi-component pellet comprises at least a first compartment and a second compartment and the steps of the method comprise

manufacturing a first compound in a reaction vessel,

removing the first compound from the reaction vessel,

introducing the first compound in liquid form to a compartmentalized article forming apparatus so as to place at least a portion of the first compound in the first compartment of a compartmentalized article formed by the compartmentalized article forming apparatus, wherein the temperature of the first compound is kept at or above its glass transition temperature (Tg) during the time period from removal of the first compound from the reaction vessel and introduction of the first compound into the compartmentalized article forming apparatus,

introducing a second compound in liquid form to the compartmentalized article forming apparatus so as to place at least some of the second compound into the second compartment of the compartmentalized article,

converting the compartmentalized article into smaller compartmentalized articles.

The compartmentalized and multi-component pellet has found use in combining separate compounds when the components react with each other or when thermal treatment of the compounds is desired.

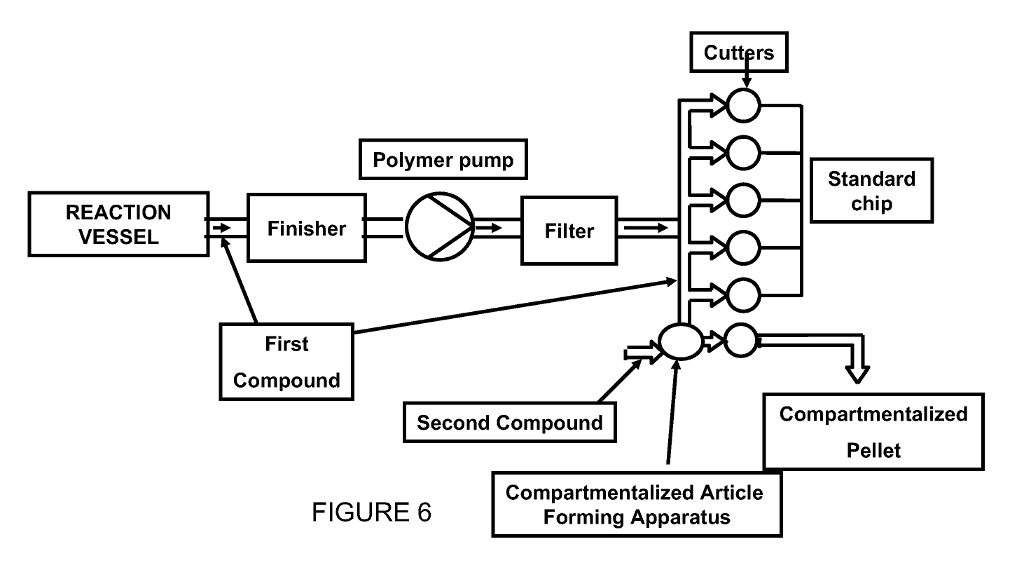

This process is depicted in FIG. 6 which shows the flow of the molten material from the reactor vessel, often done by gravity or the entrance of new material into the other end, or an extraction screw. The finisher is a type of final polishing reactor that may or may not exist in every system. Often there is a polymer pump which assists in extruding the material through a strand forming dies. In this instance, the first compound is filtered and the passed to dies and the strand cut. This shows one die which is the compartmentalized article forming apparatus.

The introduction of the second compound is shown as well. Once the compartmentalized strand or sheet is formed, the article is cut into the pellets.

In general, multilayer, or compartmentalized, pellets with an outside diameter of about 2 to 8 mm are manufactured. This description is not limited to pellets made from strands. For example, as taught in U.S. Pat. No. 5,627,218, the thermoplastic polymers can be cast into layered sheets that are then cut or smashed into a cube or square pellet form as well. These layered sheets, as well as layered strands are examples of compartmentalized articles. The compartmentalized pellet is also a compartmentalized article. The phrase converting the compartmentalized article into a compartmentalized pellet means that the size of the compartmentalized article is reduced, such as in by cutting, dicing or crushing.

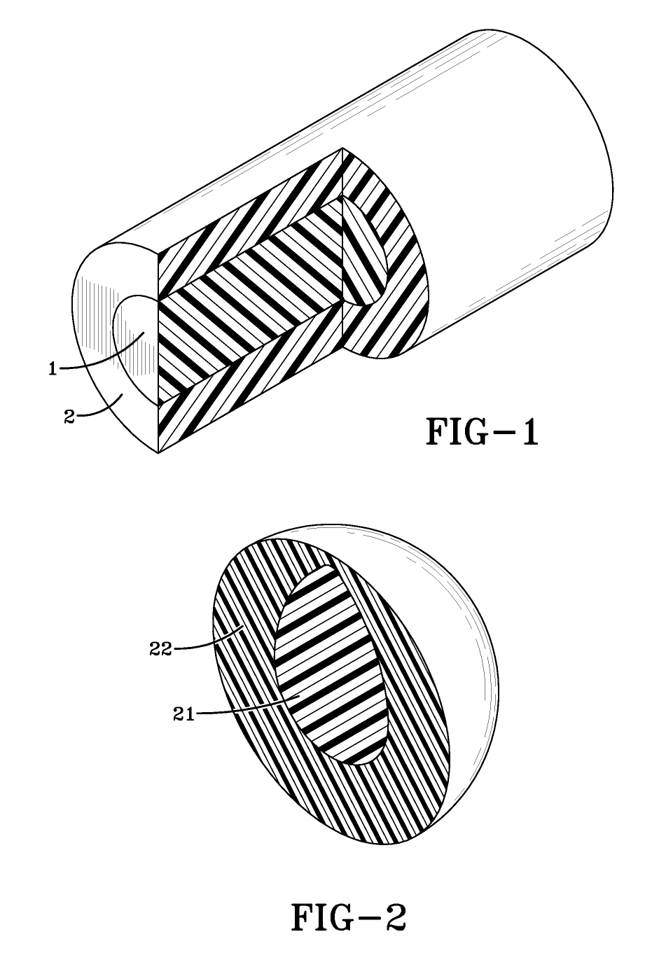

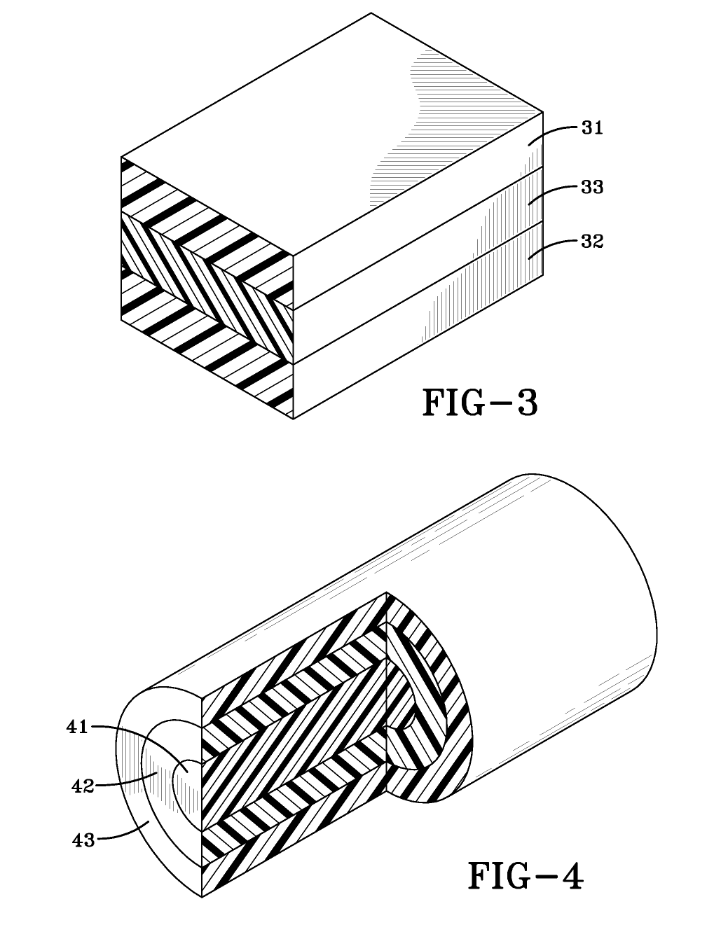

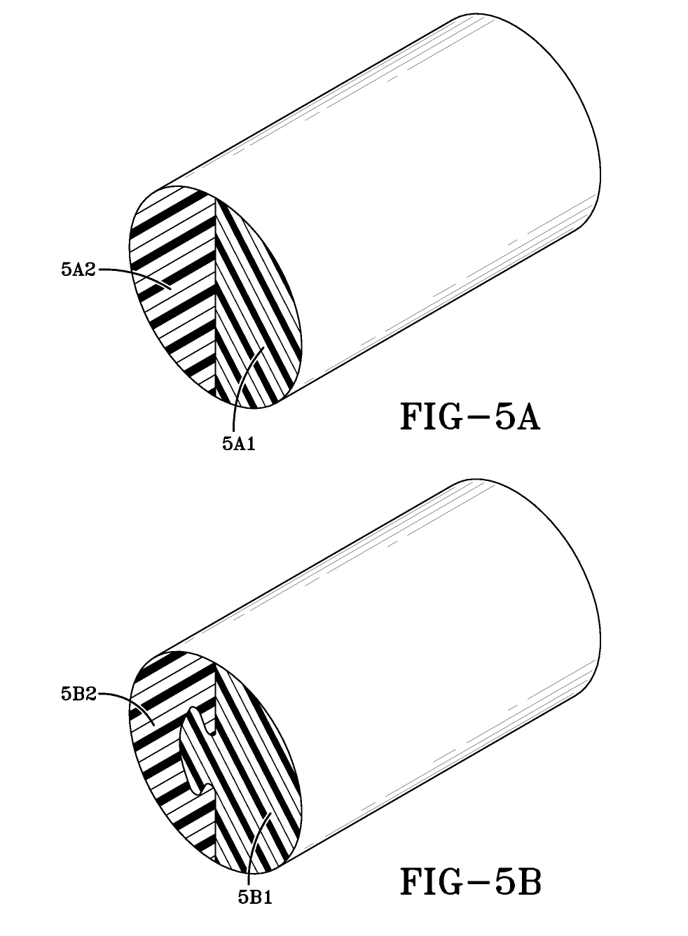

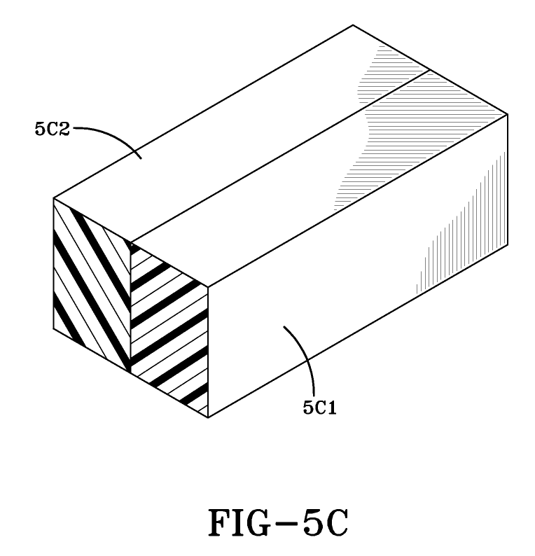

The minimum structure of the compartmentalized pellet is two layers as depicted in FIGS. 1, 2, 5A, 5B, and 5C. However a usable embodiment is depicted in FIG. 3, the sandwich or layered construction, where there are at least three layers wherein the middle layer 33 is sandwiched between a first outer layer 31 and a second outer layer 32.

The compartments of the compartmentalized article can be classified as a first compartment, a second compartment, and sequentially labeled with each increasing compartment number. For instance, a core-sheath design has a minimum of two compartments. The core sheath design could have more compartments depending upon the number of concentric rings.

The size of the compartment distinguishes it from a compartment or zone associated with a homogenous dispersion. The homogenous dispersion creates compartments holding the other compound, but these compartments are finely divided with each compartment representing a very small percentage of the total volume of the pellet. The compartments of the compartmentalized pellet are a much greater percentage of the total volume.

This is easily demonstrated using the core sheath configuration shown in FIG. 1. The percentage of the volume of the compartmentalized zone (core) relative to the whole pellet is the ratio of the radius of the core squared to the radius of the cylindrical portion of the pellet squared. This ratio can be determined by separation of the components and calculating the required volume associated with the density adjusted weight of the recovered components.

To be a compartment of the compartmentalized pellet, the volume of the compartment is preferably at least 0.001 percent of the total volume of the pellet. In practicality, 0.01 volume percent is more preferred, with at least 0.1 volume percent the most preferred.

Another embodiment of the compartmentalized pellet, depicted in FIG. 2, is to close the ends of the pellet so the inner core 21 is completely surrounded and enclosed by a sheath 21. This structure surrounds the reactive material and seals off the ends so they do not react with the by-products of thermal processing that exist in the surrounding environment or oxygen that may exist in the atmosphere during storage. U.S. Pat. No. 6,669,986 teaches that spherical, elliptical or disk-form multi-layer pellets with the overall circumference including the end face of the core material coated with sheath material can be made by rounding the cut end face. One way to make a pellet with an outer layer sheath that encloses the contents of the inner layer(s) is to cut the pellet strand next to the die underwater. One particular embodiment is an MXD6 core surrounded by a polyester copolymer sheath.

It needs to be recognized that absolute separation of the compounds in a compartment is not essential. For example, in the polyester-polyamide compartmentalized pellet, ven though the materials may be substantially in separate compartments, there may be some polyamide (MXD6) in the polyester compartment and some polyester in the polyamide (MXD6) compartment.

In the compartmentalized pellet at least two compounds are placed together in the same pellet, but in substantially different compartments. Some suitable compounds are thermoplastic homopolymers or copolymers. Examples of these include aliphatic, partially aromatic and aromatic polyamides, polyethylene terephthalate, polyethylene terephthalate copolymers, polybutylene terephthalate and its copolymers, polytrimethylene terephthalate and its copolymers, and polyethylene naphthalate and its copolymers, branched polyesters, polystyrenes, polycarbonate, polyvinyl chloride, polyvinylidene dichloride, polyacrylamide, polyacrylonitrile, polyvinyl acetate, polyacrylic acid, polyvinyl methyl ether, ethylene vinyl acetate copolymer, ethylene methyl acrylate copolymer, polyethylene, polypropylene, ethylene-propylene copolymers, poly(1-hexene), poly(4-methyl-1-pentene), poly(1-butene), poly(3-methyl-1-butene), poly(3-phenyl-1-propene) and poly(vinylcyclohexane).

These polymers are all made in reaction vessels and then extruded through a die and palletized. Thus, these polymers are suitable to be the first compound which is manufactured in a reaction vessel. The reaction vessel is a vessel in which materials to form the lower molecular weight oligomers or a vessel in which the oligomers and polymer chains are reacted with each other to form a higher molecular weight polymer. The reaction vessel also includes the finisher of a polymer reactor, provided there is some reaction occurring. For example, some propose to add isophthalic acid at the finisher and let it react into the polymer. In that instance, the finisher, which is a type of extruder, is a reaction vessel. By the same token, an extruder barrel is a reaction vessel if there is a reaction occurring, such as could happen when PMDA is introduced into a polyester melt stream.

Using polyester as an example, the practitioner would remove the molten higher molecular weight polyester from the reaction vessel and introduce the molten polyester as a liquid into a compartmentalized article forming apparatus described below. The practitioner will recognize that the reaction may be a vapour phase reaction and cooling of the reaction product to a liquid form would be necessary. Other steps could occur between removal from the reaction vessel and introduction into the compartmentalized article forming apparatus. For instance, the first compound could be filtered prior to introduction, an additive could be mixed into the first compound, or other polymer mixed as well.

It will be understood that the thermoplastic polymer suitable for use in the present invention can be made into a film, sheet, or injection molded article.

Polymers employed in the present invention can be prepared by conventional polymerization procedures well known in the art. The polyester polymers and copolymers may be prepared by melt phase polymerization involving the reaction of a diol with a dicarboxylic acid, or its corresponding diester. Various copolymers resulting from use of multiple diols and diacids may also be used. Polymers containing repeating units of only one chemical composition are homopolymers. Polymers with two or more chemically different repeat units in the same macromolecule are termed copolymers. For clarity, a polymer of terephthalate, isophthalate and naphthalate with ethylene glycol, diethylene glycol and cyclohexanedimethanol contains six distinct monomers and is considered a copolymer. The diversity of the repeat units depends on the number of different types of monomers present in the initial polymerization reaction. In the case of polyesters, copolymers include reacting one or more diols with one or more diacids, and are sometimes also referred to as terpolymers. Additionally, randomization of the monomers is not necessary. A copolymer or terpolymer also refers to a polymer with different monomers be they in block or random distribution.

Examples of suitable dicarboxylic acids include those comprising from about 6 to about 40 carbon atoms. Specific dicarboxylic acids include, but are not limited to, terephthalic acid, isophthalic acid, naphthalene 2,6-dicarboxylic acid, cyclohexanedicarboxylic acid, cyclohexanediacetic acid, diphenyl-4,4′-dicarboxylic acid, 1,3-phenylenedioxydiacetic acid, 1,2-phenylenedioxydiacetic acid, 1,4-phenylenedioxydiacetic acid, succinic acid, glutaric acid, adipic acid, azelaic acid, sebacic acid, and the like. Specific esters include, but are not limited to, phthalic esters and naphthalic diesters.

Also included are the monomers which create polyester ionomers such as metallo-sulfonates. Included in these are the sulfonated isophthalate salts of lithium, sodium, and phosphorous.

These acids or esters may be reacted with an aliphatic diol having from about 2 to about 10 carbon atoms, a cycloaliphatic diol having from about 7 to about 14 carbon atoms, an aromatic diol having from about 6 to about 15 carbon atoms, or a glycol ether having from 4 to 10 carbon atoms. Suitable diols include, but are not limited to, 1,4-butenediol, trimethylene glycol, 1,6-hexanediol, 1,4-cyclohexanedimethanol, diethylene glycol, resorcinol, and hydroquinone.

Polyfunctional comonomers can also be used, typically in amounts of from about 0.1 to about 3 mole percent. Suitable comonomers include, but are not limited to, trimellitic anhydride, trimethylopropane, pyromellitic dianhydride (PMDA), and pentaerythritol. Polyester-forming polyacids or polyols can also be used.

One suitable polyester is polyethylene terephthalate (PET homopolymer) formed from the approximate 1:1 stoichiometric reaction of terephthalic acid, or its ester, with ethylene glycol. Another suitable polyester is polyethylene naphthalate (PEN homopolymer) formed from the approximate 1:1 to 1:1.6 stoichiometric reaction of naphthalene dicarboxylic acid, or its ester, with ethylene glycol. Yet another suitable polyester is polybutylene terephthalate (PBT). PET copolymers, PEN copolymers, and PBT copolymers are also preferred. Specific co- and ter-polymers of interest are PET with combinations of isophthalic acid or its diester, 2,6 naphthalic acid or its diester, and/or cyclohexane dimethanol.

The esterification or polycondensation reaction of the carboxylic acid or ester with glycol typically takes place in the presence of a catalyst in a reaction vessel. Suitable catalysts include, but are not limited to, antimony oxide, antimony triacetate, antimony ethylene glycolate, organo-magnesium, tin oxide, titanium alkoxides, dibutyl tin dilaurate, and germanium oxide. These catalysts may be used in combination with zinc, manganese, or magnesium acetates or benzoates. Catalysts comprising antimony are preferred. Because of this pellet's desirability in food packaging, other suitable polyesters and additives are listed in USA 21 CFR 177.1000-177.2910 (revised April, 1997 edition).

Another preferred polyester is polytrimethylene terephthalate (PTT). It can be prepared by, for example, reacting 1,3-propanediol with at least one aromatic diacid or alkyl ester thereof. Preferred diacids and alkyl esters include terephthalic acid (TPA) or dimethyl terephthalate (DMT). Accordingly, the PTT preferably comprises at least about 80 mole percent of either TPA or DMT. Other diols which may be copolymerized in such a polyester include, for example, ethylene glycol, diethylene glycol, 1,4-cyclohexane dimethanol, and 1,4-butanediol. Aromatic and aliphatic acids which may be used simultaneously to make a copolymer include, for example, isophthalic acid and sebacic acid.

Preferred catalysts for preparing PTT include titanium and zirconium compounds. Suitable catalytic titanium compounds include, but are not limited to, titanium alkylates and their derivatives, titanium complex salts, titanium complexes with hydroxycarboxylic acids, titanium dioxide-silicon dioxide-co-precipitates, and hydrated alkaline-containing titanium dioxide. Specific examples include tetra-(2-ethylhexyl)-titanate, tetrastearyl titanate, diisopropoxy-bis(acetyl-acetonato)-titanium, di-n-butoxy-bis(triethanolaminato)-titanium, tributylmonoacetyltitanate, triisopropyl monoacetyltitanate, tetrabenzoic acid titanate, alkali titanium oxalates and malonates, potassium hexafluorotitanate, and titanium complexes with tartaric acid, citric acid or lactic acid. Preferred catalytic titanium compounds are titanium tetrabutylate and titanium tetraisopropylate. The corresponding zirconium compounds may also be used.

The preferred polymer of this invention may also contain small amounts of phosphorous compounds, such as phosphates, and a catalyst such as a cobalt compound, that tends to impart a blue hue. Other agents which may be included are infrared absorbers such as carbon black, graphite, and various iron compounds It is important that the first compound be kept at temperature above its glass transition temperature (Tg). In the case of polyester this is approximately 74° C., but depends upon the comonomer content. Therefore, by keeping the temperature of the first compound above its glass transition temperature, the compound can be easily transported from the reaction vessel to the compartmentalized article forming apparatus.

Because of the suitability for PET, this specification clarifies some terms. The unmodified term PET refers to polyethylene terephthalate or copolyethylene terephthalate.

Crystallinity is another way to characterize useful polymers. The modifier crystallizable refers to the ability of the polymer to be crystallized to some extent as measured by differential scanning calorimetry (D.S.C.). Typical crystallinity levels range from 5 to as high 65 percent depending upon the type of thermal treatment and nucleation techniques used. Typically a polymer will be considered amorphous when it has less than 5% crystallinity.

There are two types of crystalline structures; one is strain induced crystallinity which orders the molecules by exposing the material to force at an elevated temperature below the melt point. This type of crystallinity is also known as orientation and occurs when fibers are drawn or when bottles are stretch blown. Because of the order and orientation of the crystals, the materials with strain induced crystallinity are generally clear. Non-strain induced crystallinity occurs when the amorphous material is heated in the absence of a stress. The material will become white. This crystallinity is random in nature and is very brittle. The embodiments of this invention can be conducted on amorphous pellets (those with less than 5% crystallinity), strain induced crystalline pellets, non-strain induced crystalline pellets and pellets with both strain induced and non-strain induced crystallinity. Pellets with both types of crystallinity would come from orienting the strand during the extrusion process and then exposing the cut pellets or strand to heat sufficient to convert some of the remaining amorphous material in the pellet to a non-strain induced crystalline morphology.

The type of compartmentalized article forming apparatus used depends upon the type of compartmentalized pellet being formed. A core-sheath structure could be made as follows: The molten liquid from the reactor forms the sheath and is introduced into the compartmentalized article forming apparatus by linearly extruding the compound in the sheath of a die producing a strand. At the same time, the second compound is introduced into the core layer so the sheath concentrically covers the core. U.S. Pat. No. 6,669,986 discloses a multiple hole die apparatus to manufacture just such a core-sheath pellet. FIG. 1 depicts the core-sheath compartmentalized pellet having a core 1 which is substantially covered by a sheath 2. In one embodiment, the polyester would be extruded into the outer sheath 2 and the polyamide (MXD6) extruded into the core 1. It is apparent to one skilled in the art that the strand could consist of more than two annular concentric layers, such as FIG. 4.

The die does not necessarily have to extrude a strand prior to reducing the size of the compartmentalized article. There is one type of die-cutter arrangement known as an underwater pelletizer where the blade is right at the die face and the size of the pellet is the size of the strand that only slightly extends from the die. Therefore, the phrase reducing the size of the strand, also encompasses the embodiment where the strand is the length of the pellet.

U.S. Pat. Nos. 5,627,218 and 5,747,548, the teachings of which are herein incorporated by reference, teach many techniques for manufacturing compartmentalized pellets. If one were to make a flat sheet to be cut, one would use a multi-layer sheet die as the compartmentalized article forming apparatus which casts the sheath layer on the top and bottom and the core layer in the center.

Another embodiment is to remove an easy flowing grade of commodity injection molding quality chain terminated polystyrene from the reactor and introducing it to a compartmentalized article forming apparatus so that the chain terminated polystyrene forms the core, while the surrounding layer is composed of polystyrene of equivalent fluidity when melted, but which has not been chain terminated. The inner layer which has been chain terminated and is unreactive would also contain a solid addition polymer catalyst such as benzoyl peroxide dissolved in it.

After leaving the die as an extruded strand, the strand is cut into smaller pellets. Once these pellets are melted later, the reaction between the two polystyrenes would occur.

Because this invention removes material form the reactor, it can operate at much higher throughputs than systems which are based on remelting. This has generated some unexpected problems. For example, it has been found that a pure polyamide core with a sheath of polyethylene terephthalate creates voids at high strand production speeds. High production speeds with lower amounts of voids were obtained when the polyethylene terephthalate was placed into the core with the MXD6. Therefore, for at least the polyethylene terephthalate or polyethylene terephthalate copolymer sheath and MXD6 core construction, the core should contain polyethylene terephthalate and/or polyethylene terephthalate copolymer to improve compatibility and eliminate voids at higher production rates. The preferred amount of polyester in the core is the minimum amount required to maintain the polyester as the continuous phase and the polyamide as the dispersed phase. This preferred amount will vary by the I.V. of the polyester and polyamide.

Another way to reduce voids is to keep the strands small so the temperature gradient across the strand is minimized. The greatest success in reducing the voids is from the use of interfacial tension reducing agents, wherein the surface tension of one compound is made more hydrophilic to the other compound. In the polyester-polyamide system this can be done by copolymerizing a small amount of sulfonated, such as sodium or lithium sulfoisophthalate derived from sodium or lithium sulfoisophthalic acid into the polyester. Marked improvements are seen at levels as low as 0.5 mole percent.

To make the compartmentalized pellet, at least one other compound, the second compound, is introduced into the compartmentalized article forming apparatus so that the compound will be placed in a compartment substantially different from the first compound. This second compound will generally also be a film forming thermoplastic that can be melted and extruded. It could even be same chemical structure as the first compound, but may contain an additive as listed below.

One class of first and second compounds are polyamides. Examples of polyamides suitable for this invention can be described as comprising the repeating unit amino caproic acid or A-D, wherein A is the residue of a dicarboxylic acid comprising adipic acid, isophthalic acid, terephthalic acid, 1,4-cyclohexanedicarboxylic acid, rescorcinol dicarboxylic acid, or naphthalenedicarboxylic acid, or a mixture thereof, and D is a residue of a diamine comprising m-xylylene diamine, p-xylylene diamine, hexamethylene diamine, ethylene diamine, or 1,4 cyclohexanedimethylamine, or a mixture thereof. These polyamides can range in number average molecular weight from 2000 to 60,000 as measured by end-group titration. These polyamides can also be described as the reaction product of amino caproic acid with itself and/or the reaction product of a residue of dicarboxylic acid comprising adipic acid, isophthalic acid, terephthalic acid, 1,4-cyclohexanedicarboxylic acid, rescorcinol dicarboxylic acid, or naphthalenedicarboxylic acid, or a mixture thereof with a residue of a diamine comprising m-xylylene diamine, p-xylylene diamine, hexamethylene diamine, ethylene diamine, or 1,4 cyclohexanedimethylamine, or a mixture thereof.

Those skilled in the art will recognize many of the combinations as well known commercially available polyamides. The reaction product of the residues of sebacic acid with hexamethylene diamine is nylon 610 and the reaction product of the residues of adipic acid and hexamethylene diamine is nylon 66. Nylon 612 is another nylon which benefits from the invention. Nylon 6 is a special type of polyamide which is made by the opening of caprolactam and then polymerizing the resulting amino caprioc acid which has a formula of H₂N—(CH₂)₅—COOH. The preferred polyamide is the reaction product of the residues of adipic acid and m-xylylene diamine, known as poly-m-xylylene adipamide. This product is commercially known as MXD6 or nylon MXD6 and can be purchased from Mitsubishi Gas Chemical Company, Japan.

Additionally, the polyamide may be modified with the monomers which create polyamide ionomers such as metallo-sulfonates. Included in these are the sulfonated isophthalate salts of lithium, sodium, and phosphorous. These could be introduced for example as the dicarboxylic acid, pre-reacted diester, or diamine. U.S. Pat. No. 3,328,484, whose teachings are incorporated herein by reference, describes such modified co-polyamides.

Through this technique the following materials can be added to a reactor offtake stream. Pigments include any known organic pigment, inorganic pigment, extender and the like may be used. Examples of the organic pigment include azo pigments such as insoluble azo and condensed azo, thren system such as anthraquinone, perynone, perylene and thioindigo, phthalocyanine system such as phthalocyaanine blue and phthalocyanine green, nitroso dye such as naphthol green-B and naphtol green-Y., quinacridone, dioxazine, isoindolinone, pyrropyrrole, aniline black, and organic fluorescent pigments. Examples of inorganic pigment include natural pigments such as clay, barite, mica, etc., chromate such as chrome yellow, zinc yellow, barium yellow, etc., ferrocyanide such as Prussian blue, etc., sulfide such as zinc sulfide, etc., sulfate such as barium sulfate, etc., oxide such as chromium oxide, zinc white, titanium white, red iron oxide, iron black, chromium oxide, etc., hydroxide such as aluminum hydroxide, etc., silicate such as calcium silicate, ultramarine blue, etc., carbonate such as calcium carbonate, magnesium carbonate, etc., carbon such as carbon black, pine soot, bone black, graphite, etc., metallic powder such as aluminum powder, bronze powder, zinc powder, etc., and other burned pigments. Examples of extender include calcium carbonate, barium sulfate, talc, etc. These pigments are used individually or by mixing two or more kinds. Dyes may also be used to the range that would not impair resin properties.

Additives used for the purpose of improving resin properties such as processability, flexibility, elasticity, brittleness, manageability, etc., resin performance such as stability, durability, flame-retardant, heat insulation, etc., workability such as mold release, kneading, etc., and are not particularly limited unless they cause pyrolysis at the time of adding. Examples thereof include plasticizer, antioxidant, UV absorbent, light stabilizer, flame-resistant agent, antibacterial agent, antistatic agent, copper inhibitor, metal deactivator, tackifier, lubricant, slipping agent, internal mold release agent, defogging agent such as drip inhibitor, fog dip inhibitor, deodorant, surfactant, wetting agent, preservatives, filler, reinforcing agent, stabilizer, heat insulator, foam agent, damping material, impact resistance improver, surface treating agent, dispersant, etc.

Examples of plasticizers to be added include phthalate derivatives such as dimethyl phthalate, dibutyl phthalate, diethyl phthalate, dibeptyl phthalate, di-2-ethylhexyl phthalate, octyl decyl phthalate, etc., phthalic acid isomers such as dimethy isophthalate, dioctyl isophtalate, etc., tetrahydrophthalic acid derivatives such as di-2-ethyl hexyl tetrabydrophthalate, etc., phosphate derivatives such as tripheyl phosphate, trichloroethyl phosphate, bisphenol A dipheyl phosphate, etc., adipic acid derivatives such as dimethyl adipate, dibutyl adipate, diisodecyl adipate, diisobutyl adipate, etc., sebacic acid derivatives such as di-n-butyl sebacate, di-n-octyl sebacate, butyl benzyl sebacate, etc., azelaic acid derivatives such as d-2-ethyl hexyl azelate, dimethyl azelate, dibenzyl azalate, etc., citric acid system such as triethyl citrate, acetyl triethyl citrate, tributyl citrate, etc., epoxy system such as epoxidated soybean oil, epoxy stearic butyl, epoxy stearic octyl, etc., polyester system such as polypropylene adipate, polypropylene sebacate, etc., chlorinated system such as chlorinated paraffin, chlorinated aliphatic ester, etc., glycolic acid system such as methylphthalyl ethyl glycolate, ethyl phthalyl ethyl glycolate, etc., trimellitic acid system such as tri-2-ethyl hexyl trimellitate, etc., ricinolic acid system such as methyl acetyl ricinoleate, butyl acetyl ricinoleate, etc., butyl oleate, etc. These compounds can be used singly or two or more kinds oft them can be used in combination.

Examples of antioxidants that could be added include phenol system such as 2,6-di-t-butyl-p-Cresol, pentaerythritol-tetrakis-(3,5-di-t-butyl-4-hydroxyphenyl) propionate methyl phenol, octadecyl-3-(3,5-di-t-butyl-4-hydroxyphenyl) propionate, etc., phosphorus system such as tris(2,4-di-t-butylphenyl)phosphate, distearylpnetaerythritol diphophate, tetrakis (2,4-di-t-butylphenyl)-4,4′-biphenylene phosphonate, etc., sulfur system such as distearyl-3,3′-thiodipropionate, pentaerythritol-tetrakis-(3-laurylthiopropionate), etc. These compounds can be used singly or two or more kinds oft them can be used in combination.

Examples of UV adsorbent and light stabilizer that could be added include salicylic acid derivatives such as phenyl salicylate, p-t-butyl salicylate, etc., benzophenone system such as 2,4-dibydroxy benzophenone, 2-hydroxy-4-methoxybenzophenone, etc., benzotriazole system such as 2-(2′-hydroxy-3′,5′-di-t-butylphenyl)benzotriazole, 2-(2′-hydroxy-3′-t-butyl-5′-methylphenyl)-5-chlorobenzotriazole, etc., hindered amine system such as bis(2,2,6,6-tetramethyl-4-piperidyl)sebacate, dimethyl succinate-1-(2-hydroxyethyl)-4-hydroxy-2,2,6,6-tetramethyl piperidine condensation product, etc. These compounds can be used singly or two or more kinds oft them can be used in combination.

Examples of flame-retardant that could be added include phosphoric acid system such as allkyl diallyl phosphate, cresyl diphenyl phosphate, octyl diphenyl phosphate, triallyl phosphate, tributyl phosphate, triphenyl phosphate, tris(.beta.-chloroethyl) phosphate, tris(dichloropropyl) phosphate, tris(2,3-dibrompropyl)phosphate, tris(bromo-chloropropyl)phosphate, etc., chlorine system such as chlorinated paraffin, chlorinated polyphenyl, perchloropentacyclodecane, etc., bromine system such as tetrabromoethane, tetrabromobutane, hexaborombenzene, decabromodiphenyloxide, polydibrornophenyloxide, bis(tribromophenoxy)ethane, ethylene bisbromonorbornane dicarboxyimide, ethylene bistetrabromophthalimide, etc. reaction type such as chlorendic acid anhydride, tetrabromo phthalic anhydride, tetrabromo bisphenol A, dietoxy-bis-(2-hydroxyethyl)-aminomethyl phosphate, dibormeresyl alycidyl ether, etc. These compounds can be used singly or two or more kinds oft them can be used in combination. It is also possible to use at the same time the stabilizer for flame-retardant such as epoxy-based stabilizer.

Antibacterial agents which could be added using this technique include the phenol ether based antibacterial agent, those having the phenol group in the intramolecular skeleton, for example, 10,10′-oxybisphenoxa arsine, etc., as natural antibacterial agents, those having tropolone as a central skeleton, for example, hinokitiol, .beta.-dolabulin, etc., as glycerol ester of fatty acid, lower fatty acid monoglycerol ester, sucrose fatty acid ester, polyglycerol fatty acid ester, for example, monoglyceride caprylate, monoglyceride caprate, lauric acid monoglyceride, Sugar-ester palpitate, decaglycerol monocaprate, hexaglycerol caprylate, etc., as zeolite-based compounds, part or whole of ion-exchangeable ion in zeolite-based compounds, for example, part or whole of sodium ion, calcium ion, potassium ion, magnesium ion, iron ion, etc. is substituted with ions with antibacterial property, such as silver ion, copper ion, zinc ion, ammonium ion, etc. can be exemplified. These compounds can be used singly or two or more kinds oft them can be used in combination.

Examples of antistatic agent used in the present invention for providing a master-batch include cation system such as quaternary ammonium chloride, quaternary ammonium sulfate, etc., anion system such as allkylsulphonate, alkylbeinzensulphonate, etc., non-ion system such as poly(oxyethylene) alkylamine, poly(oxyetlaylene)alkylamide, etc., amp hoteric system such as alkyl betaine type, alkyl imidazolium type, etc., conducting resin such as polyvinyl benzyl type cation, polyacrylic acid type cation, etc. These compounds can be used singly or two or more kinds oft them can be used in combination.

Examples of copper inhibitor and metal deactivator which could be added include 1,2,3-benzotriazole, tolyltriazole amine salt, tolyltriazole potassium salt, 3-(N-salicyloil)amino-1,2,4-triazole, etc. These compounds can be used singly or two or more kinds oft them can be used in combination.

Tackifiers which can be added include coumarone resin system such as coumarone-indene resin, coumarone resin-naphthene based oil-phenol resin-rosin mixture, etc., phenol-terpene based resin system such as p-t-butyl phenol-acetylene resin, phenol-formaldehyde resin, terpene phenol resin, polyterpene resin, xylene-formaldehyde resin, etc., synthesized polyterpene resin system such as Quinton A100 (available from Nippon Zeon), Wingtack95 (available from Goodyear Chem), etc., aromatic hydrocarbon resin system such as Nisseki Neo Polymer 120, Nisseki Neo Polymer 160, Nisseki Neo Polymer T, aliphatic hydrocarbon resin system such as Escorez 1202U (available from Exxon Chemical), Escorez 1271 (available from Exxon Chemical), Taclkirol 1000, (available from Sumitomo Chemical), Tackirol 5000 (available from Sumitomo Chemical), Piccopale (available from Hercules), etc., aliphatic cyclic hydrocarbon resin system such as ARCON P-90 (available from Arakawa Kagaku), ARCON P-100 (available from Arakawa Kagaku), HI-LETZ G-100X (available from Mitsui Petrochemical Industries), etc., Aliphatic alicyclic hydrocarbon based petroleum resin system such as Escorez 1401 (available from Exxon Chemical), aliphatic aromatic petroleum resin system such as Escorez 2101 (available from Exxon Chemical), Escorez 2203 (available from Exxon Chemical), unsaturated hydrocarbon polymer system such as Escorez 8030 (available from Exxon Chemical), etc., hydrogen added hydrocarbon resin system such as Escorez 5380 (available from Exxon Chemical), Escorez 5300 (available from Exxon Chemical), etc., Hydrocarbon-based sticky resin system such as YS resin 7 (available from Yasuhara Chemical), Piccotac resins A (available from Hercules), etc., petroleum based hydrocarbon resin system such as poly-butane, atactic polypropylene, liquid-form polybutadiene, cis-1,4-polyisoprene rubber, hydrogen-added polyisoprene rubber, Claprene LIR-290 (available from Kuraray), etc., rosin derivatives system such as pentaerythritol ester of rosin, glycerol ester of rosin, rosin hydride, methyl ester of highly sophisticated rosin, methyl ester of rosin hydride, triethylene glycol ester of rosin hydride, pentaerythritol ester of rosin hydride, hydrogen-added rosin ester, high-melting point ester system resin, polymerizer rosin, resin acid zinc, hardened rosin, etc., turpentine based tackfier, copolycondensed products of synthetic resin and phthalate, nononic activator, etc., and of these compounds. These compounds can be used singly or two or more kinds oft them can be used in combination.

Examples of lubricant and slipping agents that can be added include paraffin wax system such as fluidized paraffin, natural paraffin, microwax, polyethylene wax, chlorinated paraffin, fluorocarbon, synthetic paraffin, etc., fatty acid system such as stearic acid, palmitic acid, myristic acid, behenic acid, arachidic, etc., aliphatic amide system such as aliphatic amide, alkylene bis aliphatic amide, etc., fatty acid lower alcohol such as butyl stearate, etc., ester system such as polyhydric alcohol, polyglycol ester, higher alcohol esters, etc., metallic soap such as magnesium stearate, calcium stearate, lono zinc, etc., polyhydric alcohol system such as fatty alcohol, ethylene glycol, diethylene glycol, triethylene glycol, etc., partial ester of fatty acid and polyhydric alcohol, partial ester of fatty acid and polyglycol-polyglycerol, etc. These compounds can be used singly or two or more kinds oft them can be used in combination.

Examples of internal mold release agent which could be added include perfluoroalkylbetaine, perfluoroalkylethyleneoxide adduct, ether type phosphate, synthetic organic acid ester derivative, nonion-based activator, etc., and of these compounds, one kind or two or more kinds are allowed to be used.

Examples of defogging agent (drip preventor, fog dip preventor) which could be added include sorbitan fatty acid ester system such as Mark 39 (available from Adeka Argus Chemical), Leodol SP-P10 (available from Kao), Leodol SP-O10 (available from Kao), AD-339 (available from Sakai Kagaku), Rheostat SS-60 (available from Lion), Remarkel-P-300 (available from Riken Vitamin), Remarkel S-300 (available from Riken Vitamin), Remarkel O-250 (available from Riken Vitamin), etc., Resistat AF101 (available from Dai-ichi Kogyo Seiyaku), Resistat 8200 (available from Dai-ichi Kogyo Seiyaku), Antox DFM (available from Nihon Nyukazai), PA-1743 (available from Marubishi Yuka), PA-5221 (available from Marubishi Yuka), Denon 4190 (available from Marubishi Yuka), Rheostat DGS (B) (Available from Lion), Remarkel S-105 (available from Riekn Vitamin), Remarkel S-120 (available from Riken Vitamin), Polyethylene glycol monoolate, polyethylene glycol monolaulate, etc. These compounds can be used singly or two or more kinds oft them can be used in combination.

Examples of reodorant that could be added include peroxides such as Alamaslk AF (available from Launne Poulan), Alamask AO (available from Launne Poulan), Alamask CY (available from Launne Poulan), Alamask H (available from Launne Poulan), Alamask ND (available from Launne Poulan), Rodo No. 0 (available from Bander Built), Rodo Nio. 4 (available from Bander Built), Rodo No. 10 (available from Bander Built), sodium boro hydride, lithium boro hydride, phthalic anhydride, sodium perborate, etc., vanilla essence, etc. These compounds can be used singly or two or more kinds oft them can be used in combination.

Examples of surfactants that could be added include anionic surfactants, such as carboxylate, hypoborate, cyclic hypoborate, special polycarboxylate type activator, sulfonate, alkyl or alkenyl sulfonate, alkyl allyl sulfornate, polycondensed products of alkyl allyl sulfonate, sulfate, alkyl sulfate, polyoxy ethylene-alkyl ether sulfate, polyoxy ethylene-alkyl phenyl ether sulfate, phosphate, alkyl phosphate, polyoxyethylene-alkyl (phenyl) ether phosphate salt, inorganic phosphate, etc., nonionic surfactanits, such as polyoxyethylene derivatives, polyoxyethylene-alkyl ether, polyoxyethylene-alkyl phenyl ether, polyoxyethylene-polyoxypropylene block polymer, polyoxyethylerne alkyl amine, polyoxyethyleue alkyl amide, polyhydric alcohol based derivatives, etc., cationic surfactant such as alkylamine salt, quaternary ammonium salt, etc., amphoteric surfactants, such as alkylbetaine, etc., fluorine-based surfactant, silicon based surfactant, reactive suractant, etc. These compounds can be used singly or two or more kinds oft them can be used in combination.

Examples of wetting agent which could be added include alkyl naphthalene sulphonate, alkyl sulphone succinate, sulfate, polyoxyethylene derivatives such as Adekatol NP-675 (available from Asahi Denka), Hionic DE Series (available from San Nopco), Nopco 2272-R-SN (available from San Nopco), Nopco Wet 50 (available from San Nopco), Nopco Wet 50 (available from San Nopco), etc. These compounds can be used singly or two or more kinds oft them can be used in combination.

Examples of antiseptics and fungicides which could be used include organic chlorine compound system such as pentachlorophenol, p-chloro-m-xylenol, dehydro-obi-ethylamine pentachlorophenol (available from Hercules), 4-chloro-2-phenylphenol, N-(trichloromethylthio)phthalimide, N-dimethyl-N′-phenyl-(N′-fluorodichloromethylthio)sulfamide, N-(trichloromethylthio)-4-chlorohexane-1,2-dicarboxyimide, 2,4,5,6-tetrachloro-iso-phthalonitril, etc., organic copper compounds such as copper-8-quinolinolato, etc., organic tin compound system such as bis(tri-n-butyl tin) oxide, tributyl tin laulate, tributyl tin chloride, etc., organic cyanide compound system such as 10,10′-oxybisphenoxazine (available from Bentron), Vinyzene SB-1 (available from Morton Tiokol), Vinyzene SB-5-2 (available from Morton Thiokol), etc., quaternary ammonium carboxylate (available from Rohm & Haas), 2-(4-thiazolyl) benzimidazole, etc. These compounds can be used singly or two or more kinds oft them can be used in combination.

Examples of fillers which could be used include alumina, antimony trioxide, asbestos, barite, calcium carbonate, gypsum anhydride, kaolin clay, carbon black, diatomaceous earth, feldspar powder, acid clay, quartz, graphite, magnesium carbonate, magnesium hydroxide, magnesium oxide, mica, molybdenum disulfate, agalmatolite clay, sericite, fine silicate, silicide, slate powder, talc, titanium oxide, vermiculite, volcanic ash, whiting, precipitated calcium carbonate, ground calcium carbonate, hydrate silicate, silicic acid anhydride, hydrate silicate, kaolin clay, hard clay, sintered clay, fine talc, etc. These compounds can be used singly or two or more kinds oft them can be used in combination.

Examples of reinforcements which could be added include glass thread, roving, chopped strand, chopped strand mat, glass cloth, glass tape, roving cloth, milled fiber, etc. These compounds can be used singly or two or more kinds oft them can be used in combination.

In addition, so-called water-prohibiting material can be added. The water-prohibiting material is the material that loses properties as additives which the material originally possessed by reacting with water or coming into contact with water. The strand after melt-extrusion is generally cooled by allowing it to pass the water tank, but by this method. By using the water-prohibiting material primarily for the core layer and thermoplastic resin that is inactive for water for the sheath layer in conformity to the present invention enables the manufacture of the resin containing the water-prohibiting material by the above-mentioned method. Examples of the said water-prohibiting material include adsorbent, oxygen generating agent, carbon dioxide generating agent, ethylalcohol generating agent, sulfurous acid gas generating agent, or oxygen adsorbent, etc. Examples of adsorbent include silica gel, aluminum oxide, synthetic zeolite represented by molecular sieves, natural zeolite such as mordenite, erionite, etc., clay minerals such as pearlite, acid clay, activated clay, etc., porous glass, magnesium silicate, aluminum silicate, polymer adsorbent, activated coal, activated carbon fiber, molecular sieving carbon, bone carbon, calcium oxide, calcium silicate, calcium chloride, calcium bromide, barium oxide, barium bromide, barium perchlorate, aluminum sulfate, magnesium chloride, magnesium oxide, magnesium sulfate, magnesium perchloride, aluminum sulfate, sodium sulfate, sodium hydroxide, sodium carbonate, potassium carbonate, potassium hydroxide, zinc chloride, zinc bromide, lithium perchlorate. Examples of oxygen generating agents include sodium carbonate hydrogen peroxide adduct system, calcium peroxide system, magnesium peroxide system, etc. Examples of carbon dioxide generating agent include carbonate-organic acid system, carbonate-amino acid system, carbonate-inorganic acid based carbon generating agent, etc. For the ethyl alcohol generating agent, there is, for example, an ethyl alcohol generating agent which is embedded with a water-soluble component. For the sulfurous acid gas, there are, for example, sodium hydrogensulfite system or sodium pyrosulfite system. Furthermore, for the oxygen adsorbent, there are metallic based oxygen adsorbent such as iron powder, etc. and ascorbic acid based oxygen adsorbent. For the thermoplastic resin that is used for the sheath and inactive to water, polyolefin resins such as polypropylene, polyethylene, etc, are preferable of the thermoplastic resins illustrated above.

Since of these additives, it is difficult to use a large volume of UV adsorbent, antistatic agent, light stabilizer, slipping agent, lubricant, etc., which provide particularly low compatibility to resin, and inorganic system flame retardant, filler, antiseptics, etc. for their brittleness by the conventional technique, it is extremely effective to produce a strand form of a core-sheath structure in conformity to the above teachings.

Other thermoplastics are suitable for the first and second compound and include, the polyolefins such as high density polyethylene, low density polyethylene, polypropylene and copolymers of each one.

We claim

1. A method to manufacture compartmentalized pellets wherein the pellets are comprised of at least a first compartment and a second compartment wherein the method comprises the steps of
manufacturing a first compound in a reaction vessel,
removing the first compound from the reaction vessel,
introducing the first compound in liquid form to a compartmentalized article forming apparatus so as to place at least a portion of the first compound in the first compartment of a compartmentalized article formed by the compartmentalized article forming apparatus, wherein the temperature of the first compound is kept at or above its glass transition temperature (Tg) during the time period from removal of the first compound from the reaction vessel and introduction of the first compound into the compartmentalized article forming apparatus,
introducing a second compound in liquid form to the compartmentalized article forming apparatus so as to place at least some of the second compound into the second compartment of the compartmentalized article, and
converting the compartmentalized article into smaller compartmentalized articles.

2. The method of claim 1 wherein the first compound is a thermoplastic polymer.

3. The method of claim 1 wherein the compartmentalized article forming apparatus is a die designed to form a core sheath strand.

4. The method of claim 2 wherein the compartmentalized article forming apparatus is a die designed to form a core sheath strand.

5. The method of claim 1 wherein in the second compound is a thermoplastic polymer that is not compositionally similar to the first compound.

6. The method of claim 2 wherein in the second compound is a thermoplastic polymer that is not compositionally similar to the first compound.

7. The method of claim 3 wherein in the second compound is a thermoplastic polymer that is not compositionally similar to the first compound.

8. The method of claim 1 wherein in the second compound is a thermoplastic polymer that is compositionally similar to the first compound.

9. The method of claim 2 wherein in the second compound is a thermoplastic polymer that is compositionally similar to the first compound.

10. The method of claim 3 wherein in the second compound is a thermoplastic polymer that is compositionally similar to the first compound.

11. The method of claim 1 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

12. The method of claim 2 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

13. The method of claim 3 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

14. The method of claim 4 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

15. The method of claim 5 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

16. The method of claim 6 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

17. The method of claim 7 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

18. The method of claim 8 wherein the second compound is removed from a second reaction vessel and introduced in liquid form to the compartmentalized article forming apparatus wherein the temperature of the second compound is kept at or above its glass transition temperature (Tg) during the time period from removal of the from the reaction vessel and introduction into the compartmentalized article forming apparatus.

19. The method of claim 1 wherein the first compound is a polyester and the second compound is a polyamide.
